(19) United States
(12) Patent Application Publication
(10) Pub. No.: US 2009/0319571 A1
(43) Pub. Date: Dec. 24, 2009

(54) Video indexing

(75) Inventors: Charles Lee Johnson, Newton, MA (US); Timothy R. Wall, Cambridge, MA (US); Mattew B. Wall, Cambridge, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: ITEL LLC

(21) Appl. No.: 12/214,900

(22) Filed: Jun. 23, 2008

(51) Int. Cl. G06F 17/30

(52) U.S. Cl. 707/104.1; 707/E17.009

(57) ABSTRACT

The present invention addresses the problem of marking up subject data streams and associating objects with locations in the data streams via the resulting markups. In particular, the present invention renders the subject data stream in a user interface capable of overlaying predefined markups on top of the data stream and recording user-defined markups. Indications of each markup and indications of the markup's respective location in the data stream are stored in a data store. By associating markups with objects, the objects are associated with locations in the data stream.

### BACKGROUND OF THE INVENTION

The increase of capacity in both optical and wireless networks has made it practical to distribute, or stream multimedia data to wide audiences via the Internet. Streaming media may be live or on-demand, usually depending on the content. For example, people around the world can listen to live audio commentary of sporting events streamed over the Internet. Movies, on the other hand, may be streamed on-demand.

Streaming data offers a number of advantages over downloading data. Unlike downloaded data, which must be saved in its entirety before presentation, streaming data is processed and presented immediately to the user. This is especially advantageous when presenting extremely large data files, which otherwise would necessitate long download times before being presented. In addition, streaming data does not remain behind after the presentation ends, easing local storage requirements.

The hardware and applications available for presenting streaming data are fairly mature. Clients—typically personal computers (PCs) connected to the Internet—can be used to request data streams from a server also connected to the Internet. The server may stream the requested data using either unicast or multicast techniques; multicast relies on a smart router to distribute a single stream to multiple users, whereas unicast distributes a dedicated stream to each user.

The server uses a media server application to transmit the streaming data to the client, which uses a client player application to present the streaming data to the user. The client player application receives, processes, and presents the streaming data to the user immediately, leaving no copy of the streamed data on the client after the presentation ends.

Real Player™, Windows Media Player™, and Quicktime™ are just a few of the many mature and widely available client media applications for presenting audio and video data. Client media applications can be used with PCs that use the Windows™, Mac OS™, and Linux operating systems, personal digital assistants (PDAs), and even the latest-generation cellular phones (e.g., iPhones), among other clients. Client media applications may reside on the clients as software, or they may be embedded in the clients.

More recently, the combination of streaming, search, and tagging has made it more practical to index and share multimedia data using the Internet. For example, YouTube.com lets users upload, search, and stream thousands of videos, with more added every day. Users can search for a particular stream by different pieces of video metadata (i.e., data about data), namely keyword, duration, language, and upload date. By adding metadata to a particular data file, users can make the file easier to find and share, provided that other users conduct their searches appropriately.

However, users cannot search streaming data itself. For example, suppose that a user would like to find data streams that feature a particular actor. Unless the actor's name is included in the stream metadata, a search of the data streams using the actor's name will not return any results. Even if the actor's name is included in the metadata, there is no way to determine the stream locations in which the actor appears. Metadata roughly corresponds to an entry about a book in a library catalog, rather than the index of the book in question. This shortcoming limits the utility of streaming data via the Internet, as it precludes full searches of the data stream in question.

The lack of a way to conveniently overlay annotations, or mark up data streams also makes it difficult to associate objects with locations in the data stream itself. Objects can be associated with a data stream in its entirety using the stream's metadata, but cannot be associated with locations in the data stream without using sophisticated editing techniques. This makes it difficult, if not impossible, for an average user to annotate data streams, much less associate objects with particular locations in a data stream.

### SUMMARY OF THE INVENTION

The present invention addresses the disadvantages and concerns of the prior art. In particular, the present invention provides a tool for associating objects and subject data streams using markups overlaid on top of the subject data streams.

In a preferred embodiment, a computer method and apparatus for associating objects with subject data streams allows the user to mark up a rendered data stream, which may be video data, audio data, animation, presentation slides, multimedia, and graphic data. The markups, which may be predefined or user-defined, serve to associate the subject data streams with objects; this association may be dynamic or fixed, depending on the embodiment. Indications of the markups and indications of their respective locations in the data stream are stored in a data store for use during subsequent presentations of the data stream. The invention video markup tool may also render predefined markups in the same user interface used to present the data stream.

The markups may be formed of text; for example, predefined markups may comprise closed-captioning text, song lyrics, interactive statements, and examination questions. User-defined markups may comprise comments and annotations. Markups may also be formed of code such as executable code and HTML. In a preferred embodiment, markups formed of HTML include DIV statements.

The markups may associate objects with the data stream by triggering application programs, performance tests, or database searches for the objects. For example, a markup formed of executable code may trigger an application program, which may be or may return the object associated with the corresponding location in the data stream. Alternatively, the markup may trigger a database query that returns the object associated with the corresponding location in the data stream. Such objects may be text or images, either of which may be displayed in the user interface used to present the subject data stream.

The stored indications of the markups and their respective locations in the data stream may themselves be the subject of computerized queries. In a disclosed embodiment, the user may index the subject data stream with markups formed of reference descriptors. The stored indications of the reference descriptors and their associated locations in the subject data streams form an index to the data stream that may be searched (i.e., a searchable index). In a disclosed embodiment, a database query triggered by a markup overlaid on top of one data stream may return the markup associated with a second data stream. Markups may simultaneously trigger queries and form the subject of the queries.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a functional block diagram of a system for presenting and marking up subject data streams according to the present invention.

FIG. 2 is a schematic illustration of the relationship between subject data streams, markups, and objects in embodiments of the present invention.

FIGS. 3 and 4 show schematic views of the user interface for presenting and marking up subject data streams in one embodiment.

### DETAILED DESCRIPTION OF THE INVENTION

A description of example embodiments of the invention follows.

### An Example System Embodiment for Streaming Data

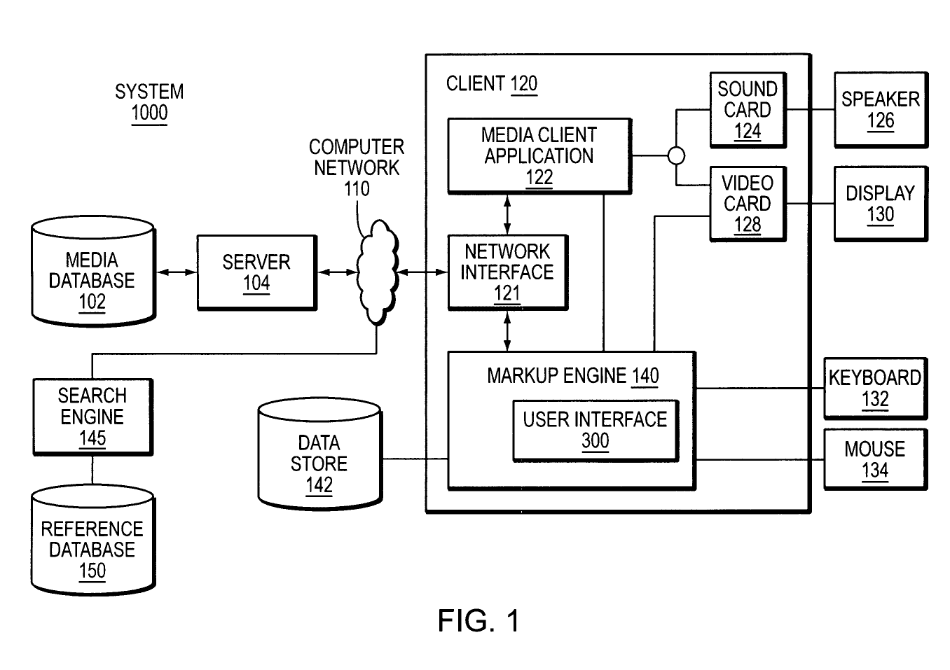

FIG. 1 shows a functional block diagram of an embodiment of a system 1000 for presenting and marking up subject data streams according to the present invention. A server 104 serves subject data streams (not shown) from a media database 102 to a client 120, which presents the subject data streams to the user of the client 120 via the speakers 126 and the display 130.

Typically, the server 104 and the client 120 are connected to each other via a global, wide-area, or local-area computer network (for example, the Internet) 110. The server 104 may comprise any standard data processor means or computer, for example, a minicomputer, a microcomputer, a mainframe machine, a UNIX machine, a personal computer such as one with an Intel processor or similar device, or other appropriate computer. The server 104 usually comprises conventional computer components (not shown) such as a motherboard, a central processing unit (CPU), random access memory (RAM), disk drives, and peripherals such as a keyboard and a display. The RAM of the server 104 stores a server operating system such as UNIX, Linux™, Windows NT™, or other server operating system. The server RAM also stores a media server application for serving data streams to clients via the computer network.

The client 120 also typically comprises any standard data processor means or computer such as a minicomputer, a microcomputer, or a PC such as one based on an Intel™ processor. Although the client 120 is normally embodied in a conventional desktop machine, the client may alternatively be embodied in a laptop computer, a PDA, a cellular phone capable of streaming data, a wireless multimedia device capable of streaming data, or any other terminal capable of presenting data streams. The client 120 includes typical computer components (not shown) such as a motherboard, a CPU, RAM, and disk drives. The client also comprises output devices such as speakers 126 and a display 130, and input devices such as a keyboard 132, a mouse or other cursor control device 134, and/or other conventional input/output devices. The client also includes a network interface 121 for communicating with other computers using appropriate network protocols.

The RAM of the client 120 stores an operating system (not shown) such as Windows XP™, Linux™, Mac OS™, or other operating system. In addition, the client RAM also has loaded in it a media client application 122 for presenting subject data streams and a markup engine 140, which is discussed in greater detail below. Example media client applications 122 include Real Player™, Windows Media Player™, Apple Quicktime Player™, and other appropriate media client applications 122 for presenting subject data streams. As is known in the art, the media client application 122 drives a sound card 124 to project audio signals via speakers 126. The media client application 122 generally presents video signals using a video card 128 to drive a display 130, which may be a liquid-crystal display (LCD) or a cathode ray tube (CRT) display.

The client 120 is networked for communication with the server 104 via the network interface 121 connected to a computer network 110, which may be a local-area network (LAN), a wide-area network (WAN), global network, such as the Internet, or other computer network. Generally, the client 120 and the server 104 communicate using the Internet Protocol (IP), although the two may use other communications protocols as well. To stream data, the server generally uses the real-time transport protocol (RTP), the real-time transport control protocol (RTCP), or other protocol capable of supporting streaming.

In general, the markup engine 140 is a software application executing within the client 120, although it may also be embedded in the client 120. The markup engine 140 stores and retrieves markups (not shown) in a data store 142 for presentation to the user via the video card 128 and the display 130. In other embodiments, the markup engine 140 may present audible markups via the sound card 124 and the speakers 126. The markup engine 140 also controls and responds to the user interface 300, through which the user controls presentation of the data stream and enters markups by means of the keyboard 132 and the mouse 134 or other input devices. The markup engine 140 also controls the association of objects (not shown) with locations in the data stream.

In a preferred embodiment, the markup engine 140 associates objects with locations in the data stream by querying a reference database 150 connected to the client 120 via the network interface 121 and the computer network 110. As the media client application 122 presents the subject data stream to the user, the markup engine 140 overlays the associated markups on top of the presentation in the user interface 300. The markups trigger the queries (and may be the subject of the queries); the markup engine 140 then classifies the query results as objects associated with the particular location in the data stream.

Associating Objects with Data Streams Using Markups

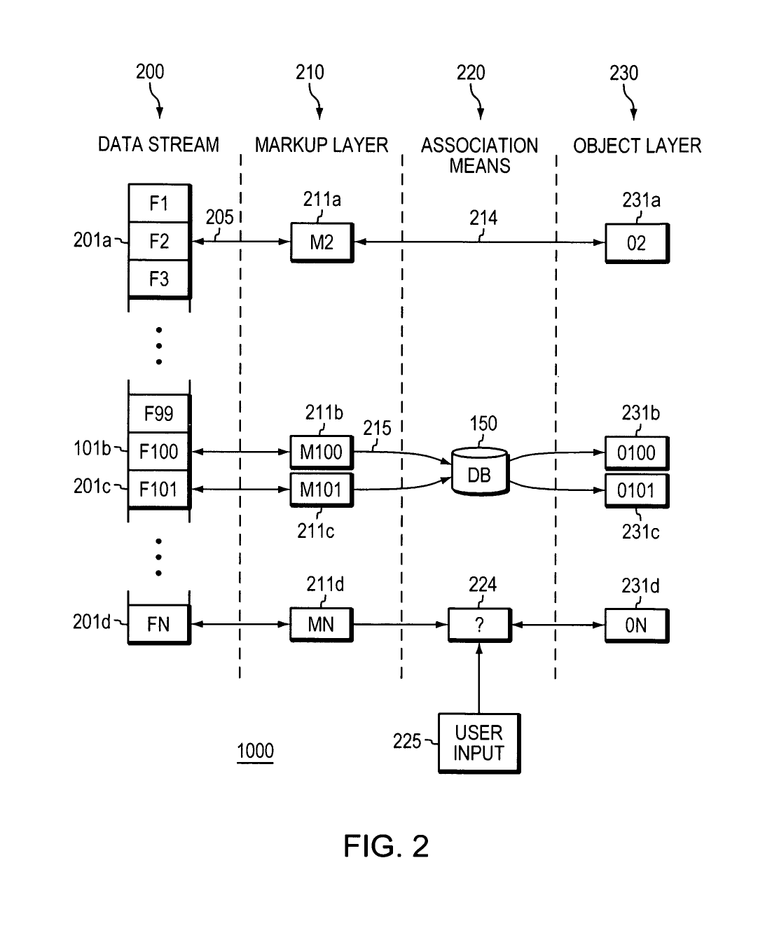

FIG. 2 illustrates the relationships between the subject data stream 200, the markups 211 and the objects 231 with locations in the subject data stream 200. Discrete locations in the data stream, or frames 201 are associated with respective markups 211. Each markup 211, in turn, triggers a corresponding association means 220 that returns respective objects 231. The markups 211 may be overlaid on top of the data stream in a markup layer 210. In a preferred embodiment, the markup layer 210 may be formed of hypertext markup language (HTML), and the markups 211 may be HTML elements bounded by DIV tags.

Markups 211 may provide the objects directly or indirectly. Frame 201a, respective markup 211a, direct association 214, and object 231a illustrate the direct relationship. Indirect association using markups 211 may take other forms, such as triggering an application program, a performance test, or a database query that returns the object associated with that particular location in the data stream. If the markup 211 is a shell script, it may cause a particular application loaded in the client RAM to open every time the presentation reaches a certain location in the data stream. The application may be the object itself or the application may return the object (i.e., the applications results produce the object 231).

Other embodiments may use markups 211b, 211c to trigger automatic database queries 215 that return query results as objects 231. In a preferred embodiment, the markup engine 140 may be linked via the computer network 110 to a search engine 145 such as Google or Yahoo (see FIG. 1). In addition to displaying the markups 211 as the presentation progresses, the markup engine 140 feeds the markups 211 to the search engine 145. The search engine 145 queries a reference database 150 using markups 211b and 211c to form database queries 215; the results of the database queries 215 form associated objects 231b and 231c. The reference database 150 may be strictly defined (e.g., a reference work, a customer database) or it may be loosely defined—for example, the Internet could be the reference database 150, and Google could be the search engine 145. If the reference database 150 changes over time, as is the case with the Internet, or the search algorithm changes, using the same markup 211c may return different objects 231c (or the same objects ranked differently) every time the data stream 200 is presented.

In a preferred embodiment, markup 211d may trigger an interactive query 224 that prompts the user to enter a user input 225. The user input 225 may then result in the associated object 231d (the user input 225 may also comprise the associated object 231d itself). Suppose that a professor has marked up a movie for his class to watch. In this case, the data stream 200 might be the movie in question and the markup 211d might be a question about the movie directed towards the user, a student. When the presentation reaches frame 201d, markup 211d appears, causing the presentation to pause until the user answers the interactive query 224. If the interactive query 224 is an exam question, the user input 225 might be the student's answer, and the associated object 231d might be the student's grade (e.g., pass or fail) as a function of his answer as user input 225.

Given the foregoing non-limiting examples of markups 211 and association means 220, it is understood that other direct associations, indirect associations, and combinations and/or hybrids thereof are suitable.

### Streaming and Marking Up Data

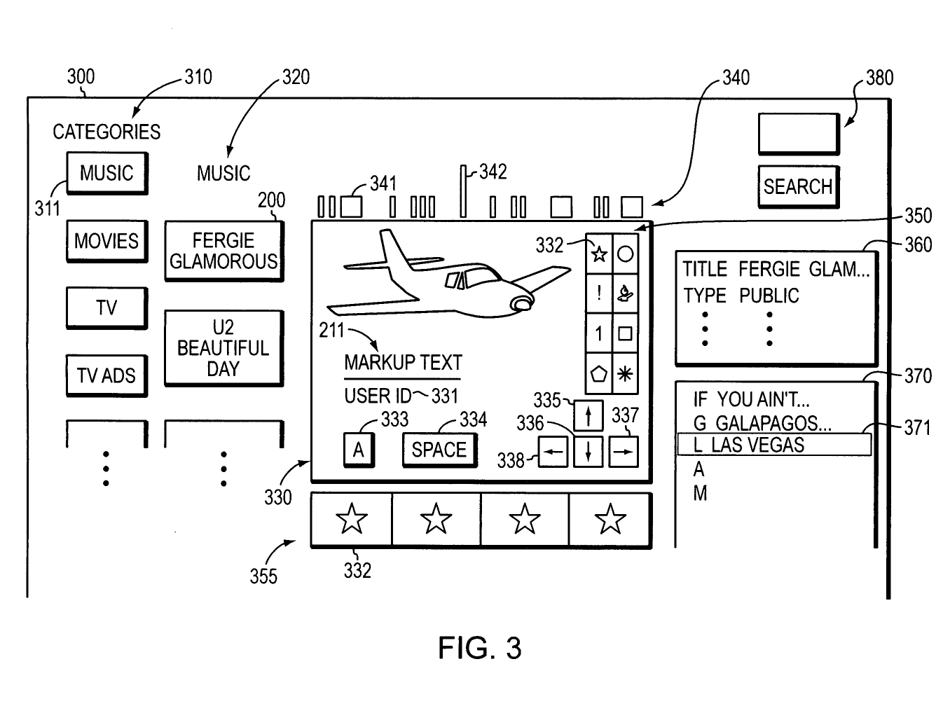

To use the invention video markup system 1000, the user begins by selecting a data stream 200 from the menus or other means in the user interface 300 shown in FIG. 3. The user can select from different data categories 311, such as music, movies, or tv, using the data category menu 310. The data stream menu 320 displays the data streams 200 available in the selected data stream category 311.

Once the user has selected a data stream 200, the markup engine 140 engages the media client application 122 to present the selected data stream 200 to the user in the presentation window 330. Metadata about the selected data stream 200—for example, the data stream title and category—appears in the stream metadata display 360. Predefined markups, such as song lyrics or closed captioning text, may appear in the auxiliary markup display 370.

A markup key 340 comprising markup icons (indicators) 341, 342 shows the locations of predefined markups 211 in the subject data stream 200. The color, width, shape, and other visual and/or audible characteristics of the markup indicators 341 may be used to denote different attributes of the individual markups 211. For example, when the data stream 200 is a TV show or a movie, red markup icons (not shown) may denote the actors' lines whereas green markup icons (not shown) may denote stage directions. Similarly, the width of the markup icon 341 may denote the relative duration of the associated markup 211 in the presentation window 330.

The user may control presentation of the data stream 200 using control buttons 333-338. The play button 335 begins or resumes the presentation, the stop button 336 halts the presentation, the forward button 337 steps forward in the data stream at one or multiple selectable speeds, and the reverse button 338 steps backward in the data stream at one or multiple selectable speeds. The user can also control whether or not markups 211 are displayed by engaging the display markup button 334.

Once the user engages the play button 335, the presentation of the data stream 200 begins. As the presentation progresses, predefined markups 211 appear in the presentation window 330 overlaid on top of the data stream 200. When a particular markup is displayed in the presentation window 330, its corresponding markup indicator 342 changes shape to highlight the current location in the data stream. The predefined markups may be song lyrics, the script of a movie or TV show, closed-captioning text, or examination questions, for non-limiting example. They may also be markups created by previous users. The presentation window 330 may display one or more markups 211 at a time associated with a particular location in the data stream 200.

In an embodiment, song lyrics, closed-captioning text, scripts, and other predefined text may constitute a special class of markup 211. The auxiliary display window 370 may be reserved for displaying this class of markup 211 in such an embodiment. As the presentation progresses, an auxiliary markup indicator 371 may scroll through the markups 211 displayed in the auxiliary display window 370 in a manner that indicates the current location in the data stream.

In a preferred embodiment, the objects 231 associated with locations in the data stream 200 may be images 332 returned from a database query based on an associated markup. The images 332 may be displayed in a vertical display pane 350 and a horizontal display pane 355 in a myriad of ways. For non-limiting example, the vertical display pane 350 may show the top eight images 332 returned by the query, whereas the horizontal display pane 355 may show plural copies of the top-ranked image 332 returned by the query.

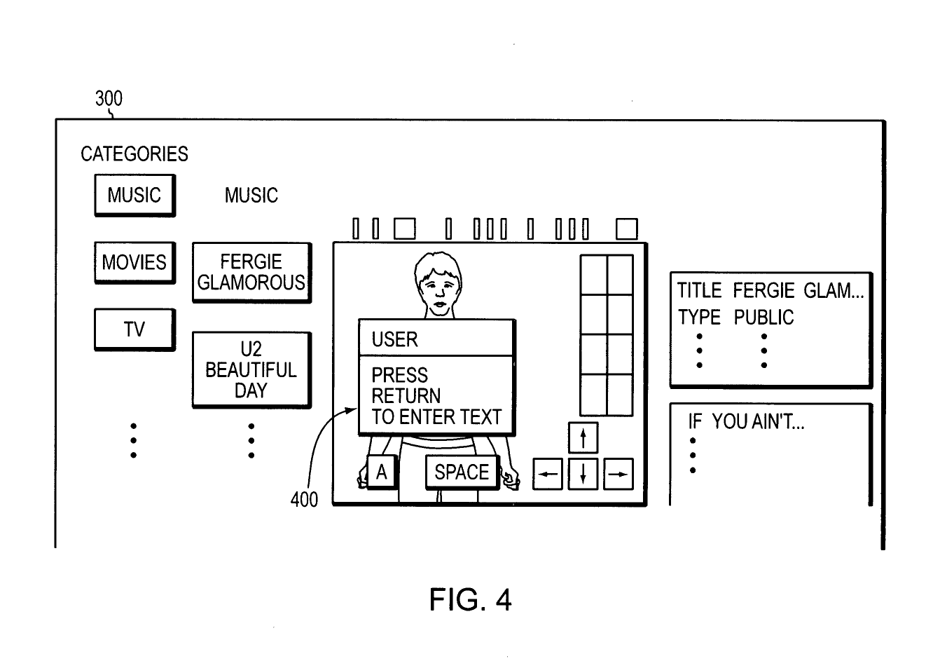

Users can enter markups 211 by engaging the add markup button 333. Engaging the add markup button 333 calls up a markup entry interface 400 shown in FIG. 4. Once the user has successfully entered the new markup 211, a corresponding new markup icon 341 appears in the markup key 340. Upon subsequent presentation of the data stream, the user-entered markup and associated user identification 331 appear in the presentation window 330 when the presentation reaches the corresponding location in the data stream 200.

One embodiment provides user entry and formation of one or more markups 211 (in addition to the above described predefined markups 211). The markup entry interface 400 enables the user to select or otherwise specify a location in the subject data stream 200 by engaging the add markup button 333 at the corresponding point in the presentation. Next, the interface 400 prompts the user to enter text, images, line art, graphics, hyperlinks, executable code, or any other suitable markup 211. The markup engine 140 (FIG. 1) saves the entered markup 211 in the data store 142 (FIG. 1) using the appropriate file format, e.g., ASCII text, HTML, PDF, JPEG, TIFF, GIFF, PNG, EPS, PS, PPM, or other suitable file format. The markup engine 140 embeds a hyperlink or other suitable marker in the user-selected location in the data stream 200; the hyperlink serves as the triggering association means 220 for the user-defined markup 211 as stored in the data store 142.

### Indexing Data Streams Using Markups

Markups 211 may also form searchable indices for data streams 200, where each markup 211 is a reference descriptor for a particular location in the data stream 200. This feature is particularly useful for indexing video and audio data streams, as the markups 211 are overlaid on top of rather than embedded in the data streams 200. For example, in the movie example presented above, markups 211 may be used to indicate appearances of a particular actor. A user searching for that particular actor can search (e.g., by actor name) the data store 142 containing the indications of the markups and their locations to find where in the movie the actor appears. In general, the data store 142 can be the target of targeted queries (i.e., queries of only the data store 142 in question) or less discriminate queries where the data store is appropriately connected to a search engine 145 (i.e., global computer network or online queries).

Markups 211 provide a new way to index data streams 200 that offers great flexibility and great simplicity. Because the data store 142 may be separate from the data stream 200, the data store 142 can be more easily searched, manipulated, or aggregated. In addition, the data store 142 can be stored using much less memory than the data stream 200, making it more convenient to save and distribute the data store 142 alone than to save and distribute a data stream 200 with embedded comments.

### Implementation of the Invention

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

This invention pertains generally to annotating, indexing, and associating objects with streaming data. More particularly, the invention is a method and apparatus for presenting and marking up streaming data, and for using the resulting markups to associate objects with particular locations in the data stream. Indications of the markups and their respective locations in the data stream are saved in a data store and overlaid on top of the data stream during subsequent presentations of the data stream.

While this invention has been particularly shown and described with references to example embodiments thereof, it will be understood by those skilled in the art that various changes in form and details may be made therein without departing from the scope of the invention encompassed by the appended claims.

What is claimed is:

1. A method of associating objects with subject data streams, comprising the steps of:
rendering a data stream;
providing one or more markups and overlaying each provided markup onto a respective location in the data stream; and
for each markup, storing in a data store an indication of the markup and an indication of the respective location of the markup in the data stream, wherein each markup corresponds to a respective object.

2. The method of claim 1, wherein the subject data stream is any of: video data, audio data, animation, presentation slides, multimedia, and graphic data.

3. The method of claim 1, wherein the markups enable triggering of any of: an application program resulting in providing the respective object, a performance test resulting in providing the respective object, and a search resulting in providing the respective object.

4. The method of claim 1, wherein the markup formed of is any of: text, HTML code, executable code, shell scripts, closed-captioning text, predefined text, song lyrics, interactive statements, examination questions, user-entered comments, and user-entered annotations.

5. The method of claim 4, wherein the HTML code includes a DIV statement.

6. The method of claim 1, wherein the markups and their locations are predefined.

7. The method of claim 1, wherein the markups and their locations are user-defined.

8. The method of claim 1, wherein the markups trigger actions during presentation of the data stream.

9. The method of claim 8, wherein the triggered actions are queries of a data store.

10. The method of claim 9, wherein the data store queries are for images.

11. The method of claim 9, further comprising a user interface in which the results of the data store queries are displayed.

12. The method of claim 1, wherein the markups form a data store of reference descriptors.

13. The method of claim 12, wherein the data store of reference descriptors is searchable.

14. A computer system for annotating data streams, comprising:
a user interface presenting data streams, the user interface configured to enable marking up data streams and overlaying the resulting markups onto locations in the data stream, each markup corresponding to a respective object;
a data store storing indications of each of the markups and indications of each of their respective locations on the data stream; and
processor means for associating each of the markups and their respective locations on the data stream to respective objects.

15. The system of claim 14, wherein the subject data stream is any of: video data, audio data, animation, presentation slides, multimedia, and graphic data.

16. The system of claim 14, wherein the markups enable triggering of: an application program resulting in providing the respective object, a performance test resulting in providing the respective object, and a search resulting in providing the respective object.

17. The system of claim 14, wherein the markup is formed of any of: text, HTML code, executable code, shell scripts, closed-captioning text, predefined text, song lyrics, interactive statements, examination questions, user-entered comments, and user-entered annotations.

18. The system of claim 17, wherein the HTML code includes a DIV statement.

19. The system of claim 14, wherein the markups and their locations are predefined.

20. The system of claim 14, wherein the markups and their locations are user-defined.

21. The system of claim 14, wherein the markups trigger actions during presentation of the data stream.

22. The system of claim 21, wherein the triggered actions are queries of a data store.

23. The system of claim 22, wherein the data store queries are for images.

24. The system of claim 22, wherein the results of the data store queries are displayed in the user interface.

25. The system of claim 14, wherein the markups and their locations form a data store of reference descriptors.

26. The system of claim 25, wherein the data store of reference descriptors is searchable.

27. A method of indexing data streams, comprising:
overlaying markups onto respective locations in a data stream; and
storing indications of each of the markups and indications of each of their respective locations in a data store.

28. The method of claim 27, wherein the markups and their respective locations are user-provided.

29. The method of claim 27, wherein the data store is searchable.

30. The method of claim 27, wherein the markups and their respective location trigger queries of data stores.

31. A computer program product comprising:
a computer-readable medium having instructions stored thereon, which, when executed by a processor, causes the processor to perform the operations of:
rendering a data stream;
providing markups to the data stream and overlaying each of the markups onto associated locations in the data stream; and
storing in a data store indications for each of the markups and their associated locations in the data stream, the markups corresponding to respective objects.
